(19) United States
(12) Patent Application Publication
(10) Pub. No.: US 2006/0280364 A1
(43) Pub. Date: Dec. 14, 2006

(54) Automatic image cropping system and method for use with portable devices equipped with digital cameras

(75) Inventors: Yue Ma, Princeton Junction, NJ (US); Jinhong Guo, Princeton Junction, NJ (US)

Correspondence Address: GREGORY A. STOBBS, 5445 CORPORATE DRIVE, SUITE 400, TROY, MI, 48098, US

(73) Assignee: MATSUSHITA ELECTRIC INDUSTRIAL CO., LTD., Osaka (JP)

(21) Appl. No.: 10/567,499

(22) PCT Filed: Aug. 6, 2004
(86) PCT No.: PCT/US04/25490

§ 371 Date: Feb. 7, 2006

Related U.S. Application Data
(60) Provisional application No. 60/493,232, filed on Aug. 7, 2003.

(51) Int. Cl. G06K 9/34; G06K 9/03; G09G 5/00

(52) U.S. Cl. 382/173; 382/309; 345/620

(57) ABSTRACT

An automatic image cropping system is for use with a portable device having an image capture mechanism and a limited resource for storing or transmitting captured information. The system includes a region of interest suggestion engine defining plural image region candidates by performing image segmentation (20) on an image stored in digital form. The engine also determines if an image region candidate is likely to be more or less interesting to a user than another image region candidate. The engine further selects an image region candidate (28) determined as likely to be of most interest to the user. In some embodiments, the engine further possesses a training module to track user interaction with the portable device and adjust future determination of likelihood of user interest accordingly.

### CROSS-REFERENCE TO RELATED APPLICATIONS

This application claims the benefit of U.S. Provisional Application No. 60/493,232, filed on Aug. 7, 2003. The disclosure of the above application is incorporated herein by reference in its entirety for any purpose.

### FIELD OF THE INVENTION

The present invention generally relates to image processing systems and methods, and relates in particular to automatic image cropping systems and methods for use with portable devices equipped with digital cameras.

### BACKGROUND OF THE INVENTION

Portable devices equipped with cameras, such as Panasonic mobile phones, have been emerging and becoming popular in the market. The resource, such as memory and storage, and the resolution of the camera lens on these portable devices are usually limited. Therefore, their uses are usually limited to the capturing of human objects for wireless image transfer. As a result, most people use the mobile phone camera just for fun. Thus, the camera on a mobile device has not reached its potential. In additional to continuing improving hardware and equipping devices with more memory and storage, more features are called for in order to increase the use of built-in cameras.

Built-in cameras on a portable device should be able to capture a variety of information from scenes or objects when a user carries it around. Examples are pictures from magazines, billboards, newsletters, catalogs; contact numbers from business cards; URL/phone number from advertisements, and other information. When capturing such information on a portable device, users often have to compliment the focus or the field of angle of the lens. As a result, users typically capture larger than desired area/blocks in the viewing area. These unnecessary regions occupy a large portion of storage space. They also consume bandwidth, thus slowing down the rendering of images on the device's LCD screen. Accordingly, there is need for a way to prevent users from capturing superfluous information.

### SUMMARY OF THE INVENTION

In accordance with the present invention, an automatic image cropping system is for use with a portable device having an image capture mechanism and a limited resource for storing or transmitting captured information. The system includes a region of interest suggestion engine defining plural image region candidates by performing image segmentation on an image stored in digital form. The engine also determines if an image region candidate is likely to be more or less interesting to a user than another image region candidate. The engine further selects an image region candidate determined as likely to be of most interest to the user. In some embodiments, the engine further possesses a training module to track user interaction with the portable device and adjust future determination of likelihood of user interest accordingly.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram illustrating a method of operation for use with a portable device having a digital camera according to the present invention;

FIG. 2 is a flow diagram illustrating a method of operation for use with a Region Of Interest (ROI) suggestion engine according to the present invention;

FIG. 3 is a flow diagram illustrating a method of training, based on interactive feedback and accumulation, parameters of a cost function employed to suggest ROIs according to the present invention; and

FIG. 4 is a view illustrating an example of segmentation and ROI selection according to the present invention.

### DETAILED DESCRIPTION OF THE PREFERRED EMBODIMENTS

The following description of the preferred embodiment(s) is merely exemplary in nature and is in no way intended to limit the invention, its application, or uses.

The present invention fulfills the needs of users to conserve memory and bandwidth resources by providing an automatic image-cropping scheme to aid users in selecting areas of interest when capturing. This scheme helps to alleviate the problem with memory or bandwidth involved with transmitting an image using a wireless handset. This scheme also facilitates zooming in on a certain object. Thus, the scheme applies to digital still cameras as well.

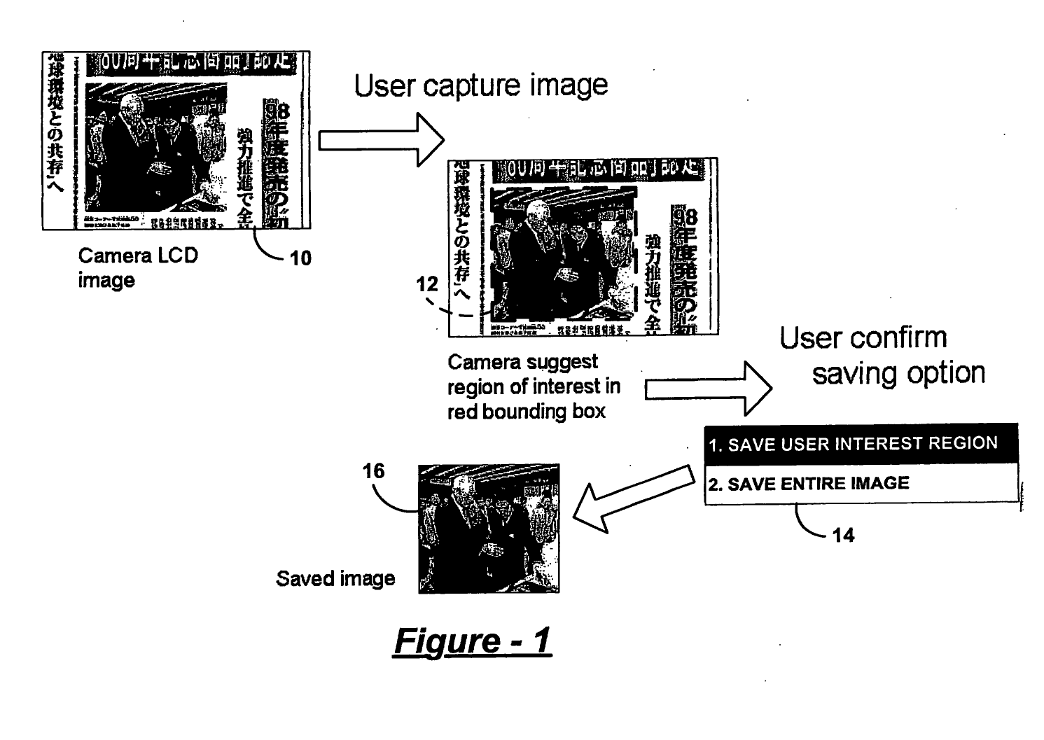

The core components of automatic image cropping are comprised of ROI (region of interest) suggestion engine and a GUI for user confirmation. The suggested ROI from the suggestion engine will be prompted to the user in an easy-to-use graphical interface. As illustrated in FIG. 1, as soon as the “shutter” is depressed, resulting in capture of image 10, suggested area 12 (in a highlighted bounding box) is prompted to the user. The user may choose at 14 to select the suggested area, show a next suggested area, or select the entire image without cropping. Based on the user's selection, the selected region can be saved or transmitted without the rest of the image as at 16. The selected area can also be zoomed in depending on the application, which also results in exclusion of image contents outside the confirmed region.

Turning to FIG. 2, the ROI suggestion engine performs color transformation at step 18, image segmentation at step 20, and entropy based image region candidate and ROI selection at step 22.

In step 18, the captured image in RGB format is transformed into HUV (Hue, Saturation and Intensity) format as discussed in A. K. Jain, “Fundamentals of Digital Image Processing”, Prentice Hall. The image segmentation and ROI selection algorithm is performed using this color representation.

In step 20, the image captured on the LCD screen is segmented based on the texture and color consistency. A fuzzy k-mean clustering method can be employed as discussed in A. M. Bensaid, L. O. Hall, J. C. Bezdek, L. P. Clark, M. L. silbiger, J. A. Arrington and R. F. Murtagh, “Validity-Guided (Re)Clustering with Applications to Image Segmentation”, IEEE Trans. on Fuzzy Systems, Vol. 4, No. 2, May, 1996. The features used in the clustering method are derived on the color differences of neighboring pixels i and j defined as
C_{diff}(i,j)={square root over ((h(i)−(h(j))²+(u(i)−u(j))²+(v(i)−v(j))²)}
where h(i), u(i) and v(i) are the HUV value of pixel i and h(j), u(j) and v(j) are the HUV value of pixel j.

Vectors calculated from Wavelet transform such as Daubechies 3 can be used to represent texture information as discussed in: Robert Porter and Nishan Canagarajar, A Robust Automatic Clustering Scheme for Image Segmentation using Wavelets, IEEE Transactions on Image Processing, Vol. 5, NO. 4, April 1996; Michael Unser, Texture Classification and Segmentation using Wavelet Transform, IEEE Transactions on Image Processing, VOL. 4, NO. 11, November 1995; and T. Chang and C. C. Jay Kuo, Texture Analysis and Classification with Tree-Structured Wavelet Transform, IEEE Transactions on Image Processing, Vol. 2, No. 4, October 1993.

In step 22, entropy based image region selection is performed in some embodiments. In a preferred embodiment, an algorithm uses entropy as one of plural criteria to determine if a region is more or less interesting to the user. A region with larger entropy contains more information, and thus may be more likely to be of interest to the user.

The entropy of an image is defined as

$$H = - {\sum }_{i} h ( i ) {log}_{2} h ( i )$$

where h(i) iεI is the histogram of the image.

The higher the entropy, the richer the colors are, and it is assumed that the region with the highest entropy is likely to be the region of interest to the user. The candidate regions are generated in the order of entropy. Considering that human perception can be different from the pure idea of richness in information measured by entropy, these candidates are selected based on several other criteria. Mainly, the size and location of the candidate areas relative to the entire viewing area are considered. Consequently, a cost function is defined as

$$C = \frac{α}{{H}_{H} + {H}_{U} + {H}_{V}} + \frac{β}{{A}_{ratio}} + γ ( \frac{\vert {X}_{c} - {I}_{cx} \vert}{w} + \frac{\vert {Y}_{c} - {I}_{cy} \vert}{h} )$$

where H_{H.}, H_{U}, H_{V} are the entropy of sub-images H, U and V respectively.

$${A}_{ratio} = \frac{{Area}_{ROI}}{{Area}_{image}}$$

is the area ratio of the ROI and the whole image. X_{c},Y_{c} is the center of the ROI while I_{cx,}I_{cy} is the center of the captured image. w, h are the width and height of the lens viewing area, respectively. α, β, γ are normalizing weights. The region with the lowest cost will be prompted to the user first. Camera sensor data (such as user focus area, camera orientation, lens aperture, etc.) may also be used in the suggestion engine.

The selection of parameters α, β, γ can be based on the characteristics of the camera and the habits of the user. For example, a camera lens with a macro may be able to capture an interested region in relatively larger scale. Therefore, the weight of Aᵣₐₜᵢₒ can be slightly higher. In yet another example, if a user always saves the entire captured image, the weight of Aᵣₐₜᵢₒ will out-weight any other parameters (α=0, β=1, γ=0) (i.e., the automatic cropping is turned off). Therefore, human behaviors and habits can be recorded and used to automatically adjust the parameters through a training process that involves interactive feedback and accumulation. The details are illustrated in FIG. 3. Initially, the parameters are set empirically to normalize and balance all three components that contribute to the cost: entropy (E), area ratio (A) and center distance (D). In an interactive feedback process, with each captured image 24, segmented blocks are identified in step 20 and four lists of these blocks are generated at step 26 according to E, A, D and their total cost: αE+βA+γD. Blocks are suggested based on their costs at step 28. The suggested blocks are available for viewing and selection, with the user selecting and confirming a region of interest at step 30. If the user does not select the first suggested region of interest, the three components E, A, D are analyzed on the selected block at step 32 and parameters are adjusted accordingly at steps 34A-34C. It is envisioned that various embodiments can analyze the components on a block in various ways. For example, a block rejected by a user can be analyzed to incorporate negative feedback. A block selected by the user after rejection of an automatically selected block can alternatively or additionally be analyzed to incorporate positive feedback. It is also possible that user confirmation of an automatically selected block can result in the automatically selected block being analyzed to incorporate positive feedback. Thus, the method in FIG. 3 can be modified and supplemented in various ways as will be readily apparent to one skilled in the art. A picture does not necessarily yield the highest entropy when the image with combination of text and pictures is being processed at grey scale level and the text region is captured out of focus (blurred). Pre-processing (smoothing) can be performed to eliminate noise in blurred text histograms.

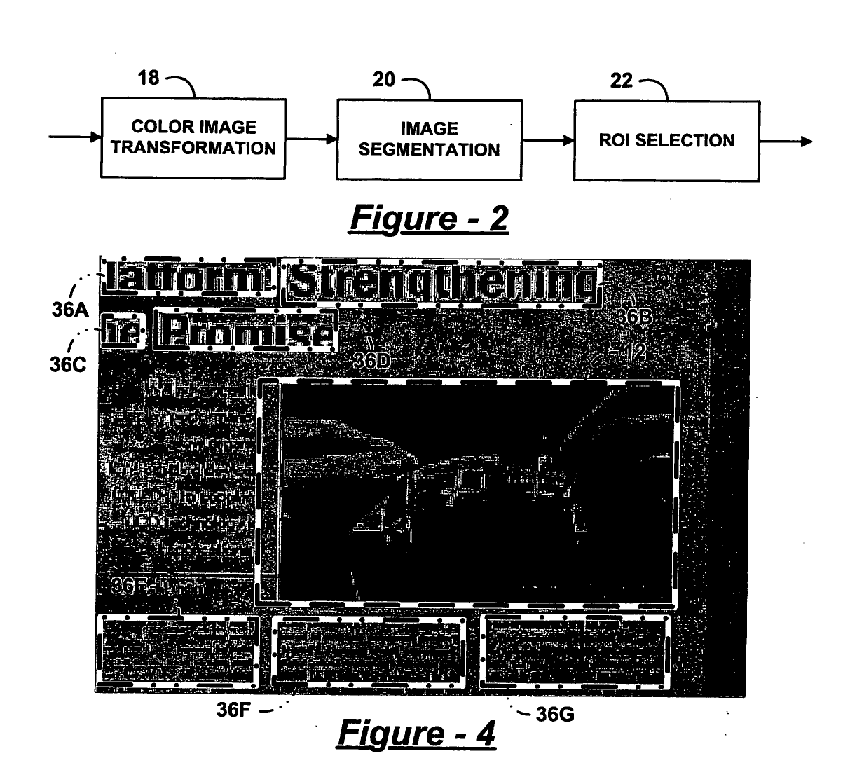

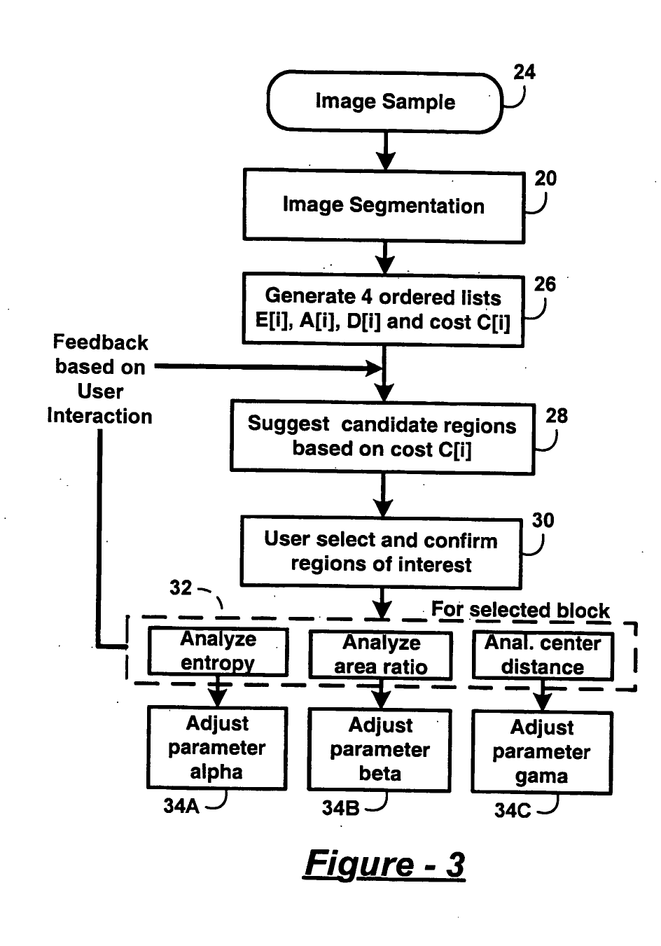

FIG. 4 is an example of an image captured using a low-end camera (Sharp) plugged into a Sharp Zaurus PDA. The segmentation result is overlaid in the figure. Using the cost function defined above, the area of the picture in the image is selected first as the region of interest, as illustrated with bounding box 12, which has a different display property than bounding boxes 36A-36G used to simultaneously identify other image region candidates. In other words, the automatic image cropping engine shows that the picture area is more likely to be the image region of interest to the user. Consequent actions can be taken upon the user's confirmation: save area, transmit this area (on a mobile phone), or zoom in this area.

It is envisioned that the user can shift focus between identified regions, and that the region having the focus will have a display property making it distinguishable from other image region candidates. Ranking the regions by entropy or lowest cost facilitates focus shifting by allowing the user to navigate from region to region with few or simplified physical interface components. In some embodiments, bounding boxes are used to indicate the image region candidates, with the hue of a bounding box around an image region candidate that has the focus being different from a hue of bounding boxes about image region candidates that do not have the focus. Example hues are red and green, but it is envisioned that other hues may be used, and that users, such as red-green color blind users, may be given the ability to select to use different display properties. For example, users may be permitted to select that bounding boxes or other indicators have a relatively more bold appearance when receiving the focus, or that such indicators exhibit different visual patterns. Additional or alternative display properties can also be used. For example, the entire image may be presented as a thumbnail, with the currently selected image region candidate primarily displayed in the active display. Also, indicators, such as bounding boxes, blocks, or lines, may be provided to the thumbnail to show image region candidates with differing display properties. Further, image contents outside all image region candidates may be permitted to blink, while image region candidates not having the focus are steadily rendered in black and white, and the currently selected candidate region is steadily rendered in color. Yet further, the active display of the device GUI may simply display one image region candidate at a time, with the entire image being treated as one of the image region candidates. Further still, the portable device may provide mechanisms (e.g., cursor, arrow button, jog dial, etc.) for users to browse through and select candidate regions. Moreover, various alternative and additional ways to accommodate user browsing, navigation, and selection of image region candidates are envisioned as will be readily apparent to one skilled in the art.

The automatic image cropping scheme of the present invention can be used in a low-resource camera device, such as mobile phone or PDA equipped with a camera, to identify regions of interest from a captured image, and only save a user desired region/block in order to save memory resource on the device.

The algorithm designed for color images and the ROI suggestion engine based on entropy therefore provides intelligence that is closer to a human's perception when capturing an object in the viewing area. Yet, the algorithm is simple to implement with less computational intensity on a low resource device.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An automatic image cropping system for use with a portable device having an image capture mechanism and a limited resource for storing or transmitting captured information, the system comprising a region of interest suggestion engine defining plural image region candidates by performing image segmentation on an image stored in digital form, determining if an image region candidate is likely to be more or less interesting to a user than another image region candidate, and selecting an image region candidate determined as likely to be of most interest to the user.

2. The system of claim 1, wherein said region of interest suggestion engine measures entropies of the image region candidates and uses entropy thus measured as a measure of likelihood of user interest.

3. The system of claim 2, wherein said region of interest suggestion engine computes a cost C according to:
$$C = \frac{α}{{H}_{H} + {H}_{U} + {H}_{V}} + \frac{β}{{A}_{ratio}} + γ ( \frac{\vert {X}_{c} - {I}_{cx} \vert}{w} + \frac{\vert {Y}_{c} - {I}_{cy} \vert}{h} )$$
where H_{H.}, H_{U}, H_{V} are entropies of sub-images H, U and V respectively,
$${A}_{ratio} = \frac{{Area}_{ROI}}{{Area}_{image}}$$
is an area ratio of an image region candidate and a common viewing area of the image, X_{c},Y_{c} is a center of the image region candidate, I_{cx,}I_{cy} is a center of the common viewing area of the image, w, h are width and height of a lens viewing area, and α, β, γ are normalizing weights.

4. The system of claim 3, wherein said region of interest suggestion engine initializes parameters α, β, γ to empirically normalize and balance all three components that contribute to the cost: entropy (E), area ratio (A) and center distance (D), generates lists of the image region candidates according to E, A, D and their total cost: αE+βA+γD, suggests the image region candidates by making them available for viewing and selection, analyzes components E, A, D on an image region candidate selected by the user, and adjusts parameters α, β, γ accordingly.

5. The system of claim 3, wherein said region of interest suggestion engine deems an image region candidate having a lowest cost C thus computed as likely to be of greatest interest to the user relative to other image region candidates.

6. The system of claim 3, wherein parameters α, β, γ are selected based on characteristics of an image capture device.

7. The system of claim 3, wherein parameters α, β, γ are selected based on habits of the user.

8. The system of claim 2, wherein said region of interest suggestion engine measures entropy of an image region candidate according to:
$$H = - {\sum }_{i} h ( i ) {log}_{2} h ( i )$$
where h(i) iεI is a histogram of the image region candidate.

9. The system of claim 1, wherein said region of interest suggestion engine segments the image based on image texture and color consistency.

10. The system of claim 9, wherein said region of interest suggestion engine uses vectors calculated from Wavelet transform to represent texture information.

11. The system of claim 1, wherein said region of interest suggestion engine employs a fuzzy k-mean clustering method to perform the image segmentation.

12. The system of claim 11, wherein said region of interest suggestion engine uses features in the clustering method derived on color differences of neighboring pixels i and j defined according to:
C_{diff}(i,j)={square root over ((h(i)−(h(j))²+(u(i)−u(j))²+(v(i)−v(j))²)}
where h(i), u(i) and v(i) are an HUV value of pixels i and h(j), u(j) and v(j) are an HUV value of pixel j.

13. The system of claim 1, wherein said region of interest suggestion engine performs color transformation on an image stored in digital form.

14. The system of claim 13, wherein said region of interest suggestion engine transforms an image in RGB format into HUV (Hue, Saturation and Intensity) format.

15. The system of claim 1, wherein said region of interest suggestion engine measures sizes of image region candidates relative to a common viewing area of the image and uses relative size thus measured as a measure of likelihood of user interest.

16. The system of claim 1, wherein said region of interest suggestion engine measures locations of image region candidates relative to a common viewing area of the image and uses relative location thus measured as a measure of likelihood of user interest.

17. The system of claim 1, wherein said region of interest suggestion engine pre-processes the image to eliminate noise in blurred text histograms to smooth the image.

18. The system of claim 1, further comprising a graphic user interface initially giving a focus to the image region candidate selected by said region of interest suggestion engine, displaying an image region candidate having the focus with a first display property visually distinguishable from a second display property employed to simultaneously display image region candidates not having the focus, shifting focus between displayed image region candidates in response to user navigation selections, and excluding image contents outside an image region candidate having the focus in response to user confirmation of the image region candidate having the focus.

19. The system of claim 18, wherein said image region suggestion engine ranks image region candidates according to likelihood of user interest, and said graphic user interface shifts the focus between image region candidates based on ranking of the image region candidates.

20. The system of claim 1, wherein the engine further comprises a training module to track user interaction with the portable device and adjust future determination of likelihood of user interest accordingly.

21. The system of claim 1, wherein said engine uses camera sensor data to determine likelihood of user interest.

22. An automatic image cropping method, comprising:
performing image segmentation on an image stored in digital form, thereby defining plural image region candidates;
determining if an image region candidate is likely to be more or less interesting to a user than another image region candidate; and
selecting an image region candidate determined as likely to be of most interest to the user.

23. The method of claim 22, further comprising measuring entropies of the image region candidates and using entropy thus measured as a measure of likelihood of user interest.

24. The method of claim 23, further comprising computing a cost C according to:
$$C = \frac{α}{{H}_{H} + {H}_{U} + {H}_{V}} + \frac{β}{{A}_{ratio}} + γ ( \frac{\vert {X}_{c} - {I}_{cx} \vert}{w} + \frac{\vert {Y}_{c} - {I}_{cy} \vert}{h} )$$
where H_{H.}, H_{U}, H_{V} are entropies of sub-images H, U and V respectively,
$${A}_{ratio} = \frac{{Area}_{ROI}}{{Area}_{image}}$$
is an area ratio of an image region candidate and a common viewing area of the image, X_{c},Y_{c} is a center of the image region candidate, I_{cx,}I_{cy} is a center of the common viewing area of the image, w, h are width and height of a lens viewing area, and α, β, γ are normalizing weights.

25. The method of claim 24, further comprising:
initializing parameters α, β, γ to empirically normalize and balance all three components that contribute to the cost: entropy (E), area ratio (A) and center distance (D);
generating lists of the image region candidates according to E, A, D and their total cost: αE+βA+γD;
suggesting the image region candidates by making them available for viewing and selection; and
analyzing components E, A, D on an image region candidate selected by the user and adjusting parameters α, β, γ accordingly.

26. The method of claim 24, further comprising deeming an image region candidate having a lowest cost C thus computed as likely to be of greatest interest to the user relative to other image region candidates.

27. The method of claim 24, further comprising selecting parameters α, β, γ based on characteristics of an image capture device.

28. The method of claim 24, further comprising selecting parameters α, β, γ based on habits of the user.

29. The method of claim 23, further comprising measuring entropy of an image region candidate according to:
$$H = - {\sum }_{i} h ( i ) {log}_{2} h ( i )$$
where h(i) iεI is a histogram of the image region candidate.

30. The method of claim 22, further comprising suggesting the selected image region candidate to a user.

31. The method of claim 30, further comprising receiving a user confirmation of the selected image region candidate.

32. The method of claim 31, further comprising processing the image based on the user confirmation.

33. The method of claim 31, further comprising segregating the selected image region candidate from at least one other part of the image in response to receipt of the user confirmation.

34. The method of claim 31, further comprising saving the selected image region candidate absent image contents external to the selected image region in response to receipt of the user confirmation.

35. The method of claim 31, further comprising transmitting the selected image region candidate absent image contents external to the selected image region in response to receipt of the user confirmation.

36. The method of claim 31, further comprising zooming in on the image region candidate in response to receipt of the user confirmation.

37. The method of claim 30, further comprising:
receiving a user contradiction of the selected image region candidate; and
selecting a new image region candidate determined as most likely to be of most interest to the user based on the user contradiction.

38. The method of claim 22, further comprising segmenting the image based on image texture and color consistency.

39. The method of claim 38, further comprising using vectors calculated from Wavelet transform to represent texture information.

40. The method of claim 22, further comprising employing a fuzzy k-mean clustering method to perform the image segmentation.

41. The method of claim 40, further comprising using features in the clustering method derived on color differences of neighboring pixels i and j defined according to:
C_{diff}(i,j)={square root over ((h(i)−(h(j))²+(u(i)−u(j))²+(v(i)−v(j))²)}
where h(i), u(i) and v(i) are an HUV value of pixels i and h(j), u(j) and v(j) are an HUV value of pixel j.

42. The method of claim 22, further comprising performing color transformation on an image stored in digital form.

43. The method of claim 42, further comprising transforming an image in RGB format into HUV (Hue, Saturation and Intensity) format.

44. The method of claim 22, further comprising measuring sizes of image region candidates relative to a common viewing area of the image and using relative size thus measured as a measure of likelihood of user interest.

45. The method of claim 22, further comprising measuring locations of image region candidates relative to a common viewing area of the image and using relative location thus measured as a measure of likelihood of user interest.

46. The method of claim 22, further comprising capturing an image in digital form.

47. The method of claim 22, further comprising pre-processing the image to eliminate noise in blurred text histograms to smooth the image.

48. The method of claim 22, further comprising tracking user interaction with the portable device and adjusting future determination of likelihood of user interest accordingly.

49. The method of claim 22, further comprising using camera sensor data to determine likelihood of user interest.
